(19) United States
(12) Patent Application Publication
(10) Pub. No.: US 2021/0081954 A1
(43) Pub. Date: Mar. 18, 2021

(54) METHODS AND APPARATUS FOR IMPROVING SECURITY IN NETWORK-SUPPORTED DYNAMIC TRANSACTING

(71) Applicants: Peter Garrett, San Francisco, CA (US); Paul Lewis Regen, Felton, CA (US); Paz Rheinstein, San Francisco, CA (US)

(72) Inventors: Peter Garrett, San Francisco, CA (US); Paul Lewis Regen, Felton, CA (US); Paz Rheinstein, San Francisco, CA (US)

(21) Appl. No.: 17/014,920

(22) Filed: Sep. 8, 2020

Related U.S. Application Data
(60) Provisional application No. 62/897,976, filed on Sep. 9, 2019.
(60) Provisional application No. 62/911,268, filed on Oct. 5, 2019.

(51) Int. Cl. G06Q 20/40; H04L 29/06; G06Q 20/10; G06Q 20/32; G06Q 20/36; G06Q 20/34; G06Q 20/38; G06Q 20/20; G06K 7/10; H04L 29/08; H04B 5/00

(52) U.S. Cl. CPC G06Q 20/40145; G06Q 2220/00; G06Q 20/108; G06Q 20/3223; G06Q 20/326; G06Q 20/3674; G06Q 20/341; G06Q 20/4018; G06Q 20/385; G06Q 20/204; G06Q 20/3278; G06K 7/10297; G06Q 20/321; H04L 67/10; H04B 5/0031; H04L 63/0861

(57) ABSTRACT

A method is provided for authenticating dynamically generated virtual credit card (VCC) data or virtual account number (VAN) data assigned to an electronic account for network distribution to one or more than one transaction device for use in electronic transacting.

### CROSS-REFERENCE TO RELATED DOCUMENTS

This case claims priority to provisional patent application 62/897,976 filed on Sep. 19, 2019 and provisional patent application 62/911,268 filed on Oct. 5, 2019. Both of the referenced provisional applications above are included herein at least by reference.

### BACKGROUND OF THE INVENTION

### 1. Field of the Invention

The present invention is in the field of financial transaction technologies, more particularly transaction technology as practiced over a network from a point of sale (POS) device or from a network interface node (NIN) and pertains particularly to methods and apparatus for improving transaction security and convenience for transacting parties.

### 2. Discussion of the State of the Art

Dynamic smart, cards and mobile wallet applications may be storage sites for multiple credit and debit card data that may be stored on a local secure element (card memory, device memory, network node memory). Recently the advent of cloud computing has made it possible to store an unlimited amount of payment card data sets in a network cloud service like a cloud wallet. Such information may, due to the nature of the Internet and connected sub-networks, be accessed from any geophysical location within network coverage such as in online shopping.

The ability to transact oilers a great convenience but still poses a threat to security of the transaction, especially for transactions where a transaction card not present (online credit and debit card use). Some banks and card issuers have issued virtual credit cards (VCCs) or virtual account numbers (VANs) to their account holding customers to use while transacting online in an effort to combat fraud, Since most online retailers store their customers' payment data. It is convenient for all parties to a transaction not to have to re-enter payment data every time they want to complete a transaction. But even in such cases, it is possible for a hacker to gain network access to that data marking a credible risk of identity theft and other types of fraud.

A VCC or VAN depends upon an application running on a computing device connected to the network to generate new credit or debit card numbers, or tokens thereof, for every single transaction a user makes. The generated token or “image” is transmitted between the bank and the retailer to confirm that the data is approved for the transaction being made. A benefit of VCC/VAN generated tokens is that unlike a static token based on printed card data, the one use tokens may not be used be used again after it is used once in a transaction rendering it useless to hackers.

A current liability with VCC/VAN is it may only be used when shopping online without a transaction card or device. Therefore a consumer or retailer may not be afforded the protection from fraud when a transaction card is used at a POS terminal. The inventor is aware that theft of data and fraud in transactions where a card is not used has increased such that by 2023, it is estimated that $130 billion in revenue may be lost by business due to fraudulent transactions where no card is present.

Other potential security issues may be associated with transactions using near field communication (NFC), for example, to transfer card data wirelessly at short range from a computing device to a POS terminal reader. User convenience is one benefit of NFC-based systems. NFC makes it easy for users to complete instant payments using, for example, a smart phone, or tablet, supporting or not supporting a mobile wallet application also referred to herein as a mobile wallet. This process of payment is also simple to understand and use. It helps users perform financial transactions at the touch or tap of their device screens.

NFC is a versatile technology covering a range of different industries and services. NFC may be used in transacting relative to mobile banking, restaurant, movie tickets, train tickets, receiving updates on expenditures and rewards points, redeeming rewards and coupons, and more. NFC is useful in the academic arena as well. The high level of encryption inherent to NFC file or data transfer enables institutions to employ it as a sort of a security system. Such a system may, for example, be employed to validate student identification, for example, entering and exiting a premise. Employees of companies may use NFC to seamlessly interact in the office environment sharing real-time information with each other.

It may be generally remarked that the use of mobile wallets is, to an extent, safer than using physical credit cards. On a mobile device, a user's card data is typically password and or personal identification number (PIN) protected. Moreover, NFC-enabled payment cards are more secured against fraudulent actions than are magnetic strips of typical credit/debit payment cards.

While NFC transactions may be more secure than regular credit card payments, the technology is not completely secure.

Mobile phone hacking is now occurring on a wider scale and hackers have wrought new methods and apparatus to gain control of or unauthorized access to personal data, social security data and financial data of users. Greater security is desired both online card and card transactions including NFC transactions. Therefore, what is clearly needed is a security regimen and supporting apparatus to improve transactional security online, or at a POS terminal overcoming or greatly reducing the problems discussed further above.

### BRIEF SUMMARY OF THE INVENTION

According to an embodiment of the present invention, a method is provided for authenticating dynamically generated virtual credit card (VCC) data or virtual account number (VAN) data assigned to an electronic account for network distribution to one or more than one transaction device for use in electronic transacting including the steps (a) issuing from a first service entity having a first server connected to the network, one or more money accounts to a user owning the one or more than one transaction device, the one or more money accounts stored at the first service entity or at a second service entity having a second server connected to the network as account transaction data on at least one data repository connected to the network, the one or more money accounts authenticated to the user by at least one biometric sample submitted to the first or second service entity for repeated reference to authenticate the user, (b) requesting a dynamic virtual credit card number or a virtual account number from the second or first service entity, or from a third service entity having a server connected to the network, the request generated through a mobile service application running on the one or more than one transaction device to represent the transactional data of one of the one or more money accounts, (c) submitting at least one or a combination of biometric samples to the second or first entity servers to obtain user verification for the request of (b), (d) comparing the submitted biometric signature(s) to the biometric signature of (a), (e) upon successful verification result in (d), sending the verification and request data to the issuing first service entity over the network from the second service entity, or to the third service entity of (b), and (f) upon receiving verification success and request data of (e), generating at the first, second or third service entities a VCC or a VAN and sending that and confirmation of active status of the VCC/VAN to the one or more than one transaction device or to one of the other service entities for subsequent distribution to the one or more than one transaction device.

In one aspect of the method, in (a) the first service entity is a financial institution that issued the finances account or accounts and wherein the second service entity is a cloud digital wallet account service. In one aspect of the method in (a), the biometric sample is one or a combination of a fingerprint scan, a voice sample, a facial recognition image, or an electrocardiogram sample. In one aspect, in (a), the one or more transaction device is a mobile phone, or a dynamic smart card wirelessly paired to a mobile phone. The wireless connection may be bluetooth or NFC or any other viable wireless service available or will be available in the future.

In one aspect of the method, in (b) the mobile service application is running on a transaction device that is a mobile phone. In one aspect, in (c) the one or more than one biometric samples include a fingerprint scan submitted to the wallet account service, which in turn contracts with the financial institution for generating and activating the VCC/VAN requested or for activation of the VCC/VAN requested, the VCC/VAN generated by the wallet service or the third service entity. In this aspect, in (c) the third service entity generates the dynamic VCC/VAN numbers as a specialized service on demand.

In one aspect of the method, in (d) the comparison is made at the wallet account service functioning as the second service entity. In one aspect, in (e) the second service entity is the wallet account service and the first service entity is the financial institution that issued the one or more money accounts. In one aspect, in (f) the VCC or VAN includes a card number, an expiration time or date, and a credit verification value (CVV). In another aspect of the method in (f) the VCC or VAN has a lifetime measured in hours. In one aspect, in (f) the VCC or VAN may be used for a stated number of transactions. In still another aspect, in (f) the VCC or VAN may be used for a single transaction.

In one aspect of the method, in (f) the VCC or VAN is used by a dynamic smart card at a point of sale terminal (POS) having a card reader. In another aspect, in (f) the VCC or VAN is used by a mobile phone having a near field communications (NFC) chip at a POS having an NFC interface. In one aspect of the method, in (f) the VCC or VAN is distributed to a wearable transaction device in the form of a watch.

### BRIEF DESCRIPTION OF THE SEVERAL VIEWS OF THE DRAWINGS

FIG. 1 is an architectural overview of a transaction carrier network supporting enhanced security measures for mobile transactions completed over a network.

FIG. 2 is an architectural view of a network supported transactional relationship between network nodes and at least on end node initiating a secure transaction using a virtual credit card (VCC) or virtual account number (VAN) according to an embodiment of the present invention.

FIG. 3 is a process flow chart depicting steps for improving security for a wallet account.

FIG. 4 is a process flow chart depicting steps for requesting a VCC or VAN number and activating that number.

FIG. 5A is an elevation view of the mobile phone of FIG. 1 displaying a cloud wallet application screen according to one embodiment.

FIG. 5B is an elevation of the mobile phone of FIG. 5A depicting a VCC/VAN interactive request interface displayed in screen 119.

FIG. 6 is a front elevation view of the mobile phone of FIGS. 5A and 5B receiving an approved VCC/VAN/CVV for use or transfer according to an embodiment of the present invention.

FIG. 7 is an elevation view of the mobile telephone of FIG. 1 transferring VCC/VAN/CVV data to at least two transaction devices.

FIG. 8 is a block diagram depicting a near field communication (NFC) shut-down circuit according to an embodiment of the present invention.

FIG. 9 is a block diagram depicting the NFC shut-down circuit of FIG. 8 with added circuitry for preventing display of at least the static or dynamic card verification value (CVV) on the transaction device.

### DETAILED DESCRIPTION OF THE INVENTION

In various embodiments described in enabling detail herein, the inventor provides a unique apparatus and methods for improving transactional security using virtual credit card (VCC) virtual account number (VAN) and near field communication (NFC) transactions. The present invention is described using the following examples, which may describe more than one relevant embodiment falling within the scope of the invention.

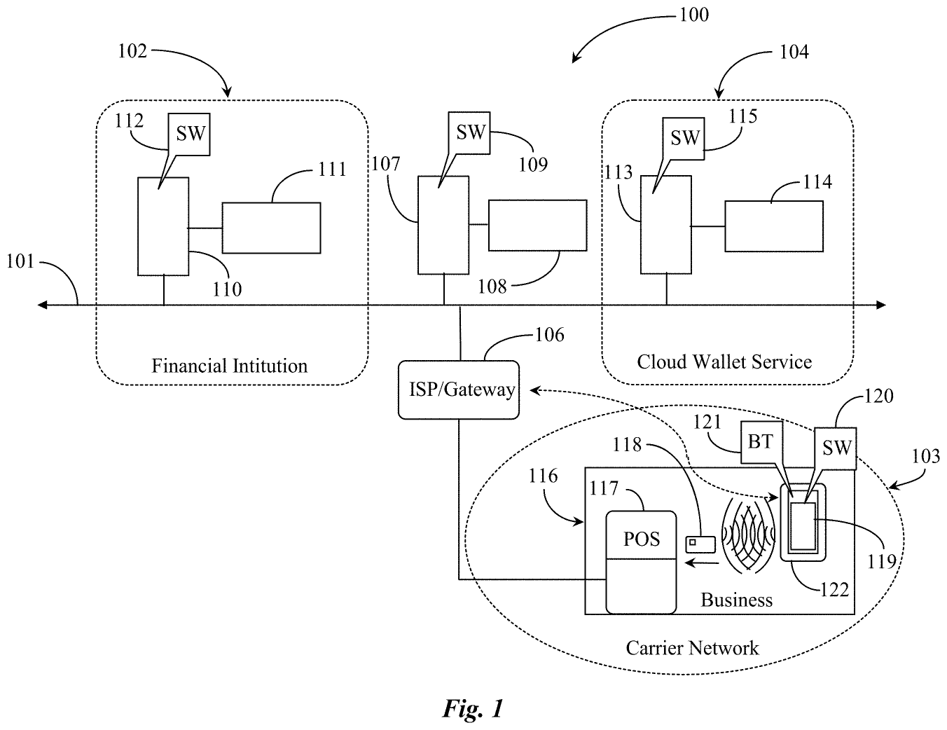

FIG. 1 is an architectural overview of a transaction carrier network 100 supporting enhanced security measures for mobile transactions completed over the network. Network 100 includes network backbone 101. Network backbone 101 may represent all lines, equipment, and access points, routers and gateways that make up the network as a whole including connected sub networks. Network 100 may be a data communications network like the Internet network or another wide-area-network (WAN) without departing from the spirit and scope of the present invention. There are no geographic limits to the practice of the invention.

Backbone 101 supports a network cloud labeled cloud wallet service 104. Cloud wallet service 104 may be adapted by a financial mobile cloud wallet service company to store credit card data, debit card data, and other electronic card or account data, for a mobile user, represented herein as user phone 122 having a dynamic transaction card 118 that may be programed with a selected set of card transaction data, for example, to make a specific transaction. Cloud wallet service 104 includes a server 113 supported by back bone 101 running a software (SW) application 115 and coupled to a data repository 114. SW 115 may be a cloud wallet application for a dynamic transaction device like card 118 or another device used to interact with a sales or banking terminal (electronic machine/network node). Data repository 114 may include user identification and profile data user accounts data, financial history data including transaction history, cloud wallet account data and the like. In one embodiment, service 104 represents a pay money service adapted like a cloud wallet service, to pass account data to a user to cover a transaction made by the user.

Network 100 may include one or more financial institution domains 102 interfacing with a bank, credit union, or other financial account service site that may provide banking services to user 122 as a client. Domain 102 is a financial institution that may issue a financial transaction device to user 122 based on client status and account information. Financial institution 102 broadly represents entities that may be considered financial institutions with services used by user 122 like banks, credit unions, investment houses, etc. Financial institution 102 includes a server 110 supported by back bone 101. Server 110 hosts a software (SW) application 112 adapted to provide an electronic interface as a tool to user 122 for account use and management. SW 112 may include at least one component adapted to cooperate over a network with SW 115 running on server 113 in cloud wallet service domain 104.

Communications network 100 may include at least one network-based point of service (POS) node representing products or services referenced herein by a server 107 supported by backbone 101, and a software (SW) application 109 executing on server 107. Server 107 may represent any entity (network node) accessible to the user where a transaction may be performed. A data repository 108 may hold service and product related data, user interaction history and any transaction history a user like 122 might have at a site.

Access to communications network backbone 101, which may represent the Internet in one embodiment, may be through an Internet service provider (ISP)/access Gateway 106 supported by backbone 101. A carrier network 103 is depicted that enables communications including wireless communications to be bridged onto communications network 100 through ISP Gateway 106. Carrier network may be a wireless 5G network or similar mobile network that user-operated mobile phone 122 may use to access the network and practice local and long-distance communications using the representative mobile telephone. Mobile telephone 122 may be Bluetooth™ enabled by hardware and software (SW) 121 labeled BT. Mobile phone 122 may host a software (SW) application 120 adapted as a thin mobile SW application including a network connection and browsing ability that may locally display information screens like a screen or display window 119 in display on mobile phone 122.

The user operating mobile phone 122 is at a business domain 116. Domain 116 may be a service site, restaurant, retail establishment, parks service, or any venue that user 122 may enter to perform an electronic transaction for a product or service. In this embodiment, business 116 includes a point of sale (POS) machine or terminal 117 that takes, at least, credit and debit cards for satisfying financial transactions made by user 122. In this embodiment, user 122 has a dynamic universal transaction card 118 that may be electronically associated to a funding source account and may be accepted by terminal 117 to pay for goods or services. In a preferred embodiment, user 122 may transmit account data to card 118 from the mobile telephone while running SW 120 and SW 121 wherein the card 118 is Bluetooth™ enabled to at least receive the account data (card number) wherein the account data represents an account that user 122 has represented in cloud wallet service 104.

User 122 may have several different accounts represented in cloud network 104 and dynamic transaction card 118 may be loaded with any of the user's account data to use that account to pay for goods or services during a transaction. SW 120 on mobile phone 122 enables the user to interact with cloud network 104 just before using card 118 at POS terminal 117 so that the user may determine which of several accounts might be imprinted to card 118 for use as a device representing that account.

Cloud wallet application screen 119 on mobile phone 122 may be part of the interactive interface available to the user operating mobile phone 122 to load card 118 with a card number, security code, and other pertinent data so the card may be used as a card of the selected account. Any new account data that the user loads onto card 118 may overwrite any previous account data on the card memory.

In a preferred embodiment, SW 115 executing on server 113 in cloud wallet service 104 is adapted to generate and transfer or to transfer a third-party generated virtual credit card (VCC) number or a virtual account number (VAN) to a user like a user operating phone 122 whereby the user may use that data to perform a transaction from the mobile phone 122 adapted with near field communication (NFC), or whereby the user may transfer the received VCC or VAN number to a transaction device cable of wireless communication with the phone. Card 118 may be used as the transaction device to pay for one or more transactions at POS terminal 117, the card receiving card data from mobile phone 122 executing application 119 in broad respect while card 118 represents a particular account listed in cloud wallet service 104.

As described in the background section, banks and institutions able to issue credit cards, debit cards, have more recently begun to issue VCCs or VANs to their customers like a user operating phone 122 for use in online shopping such as at server 107. VCC/VAN applications generate a new numerical credit or debit card number, or token, for every single transaction a user performs. The VCC/VAN token or data is synchronized between the bank and the retailer to confirm a transaction.

A stated goal of the invention is to improve security for online (network) transactions using VCC and or VAN numbers generated by a financial institution like institution 102. Cloud wallet server aided by SW 115 is adapted to enable user authentication or validation when requesting a VCC or VAN number from the cloud wallet service and may once approved, receive a generated VCC number set or VAN number set through a cloud wallet account SW 120 executing on the user's mobile phone 122. SW 115 may leverage biometric data provided by the user matching newly provided data with biometric data on file at the cloud wallet service 104. The user may then use an issued VCC or VAN at a card-present transaction at a POS terminal like terminal 117. The issued VCC or VAN may represent the card data of a credit card or account listed in the user's account list.

In one embodiment of the invention, a user like user operating mobile phone 122 may through application 120 and display interface (screen) 119 may send a request for a new VCC or VAN assigned to any of the user's active accounts held in wallet service 104 to server 113 aided by SW 115. In this embodiment, the user has previously submitted bio-metric data to cloud wallet service 104 as part of this VCC/VAN issue service.

Cloud server 113 aided by SW 115 may ask the user for routine password or personal identification credentials and a fresh biometric signature from mobile telephone 122 for the purpose of authentication the user to pass a VCC or VAN data set to mobile phone 122 through application 120. The biometric signature may be a fingerprint (FP) signature taken as a touch screen interaction through screen 119 leveraging the fingerprint application installed on the user's phone 122. Other biometric signatures that may be requested in place of or in addition to FP may be a voice signature, an electrical cardiogram signature (ECG), facial recognition (FR), retinal scan or eye scan, or some combination thereof.

In the VCC/VAN request, the user operating phone 122 may determine which wallet account to request the VCC/VAN for and may in a variation of the embodiment set a desired time or number of times the VCC/VAN may be repetitively used. In current art, a VCC/VAN is used once and can only be used in a transaction where no card is used such as at server 107 representing an online retail site server 107 aided by SW 109.

Once a request with a biometric signature is received, server 113 aided by SW 115 matches the biometric signature received in the request to that held on file for that user. Once approved at server 113, server 113 may pass the data including a certificate of authentication to an institution like institution 102 issuing VCC/VAN numbers. The card issuing bank, for example, may upon receiving the data from server 115 at server 110 aided by SW 112, issue a fresh VCC or VAN for the user and send it back to the cloud wallet service at server 115. The cloud wallet service may then pass the VCC/VAN to mobile phone 122 with confirmation when the number is active and can be used accordingly.

In a slight variation to the above embodiment, the wallet service 104 may issue the VCC/VAN and pass it to the user operating mobile phone 122 and then pass the evidence of authentication to the issuing bank or financial institution 102 and have the financial institution make the final decision by activating or not activation the issued number data or token (if used). Once the VCC/VAN is ready for use, the user may transfer that data to a dynamic smart card other transaction device like card 118, for example, overwriting the transaction memory (secure element) with the new data. The card 118 may then be used in the transaction at POS 117. The merchant checks the status with the financial institution on validity of the card as it would any other card wherein the institution is able to confirm the number and account veracity.

Though a user operating mobile phone 122 may request a VCC/VAN from a financial institution that issues them, those may only be used at network interfaces such as at retail server 107 aided by SW 109. In one embodiment of the present invention, the user may request a VCC/VAN through cloud wallet service 104 with biometric authentication for expanded use at an online interface such as a POS website checkout page. Other such embodiments variations are described in more detail below.

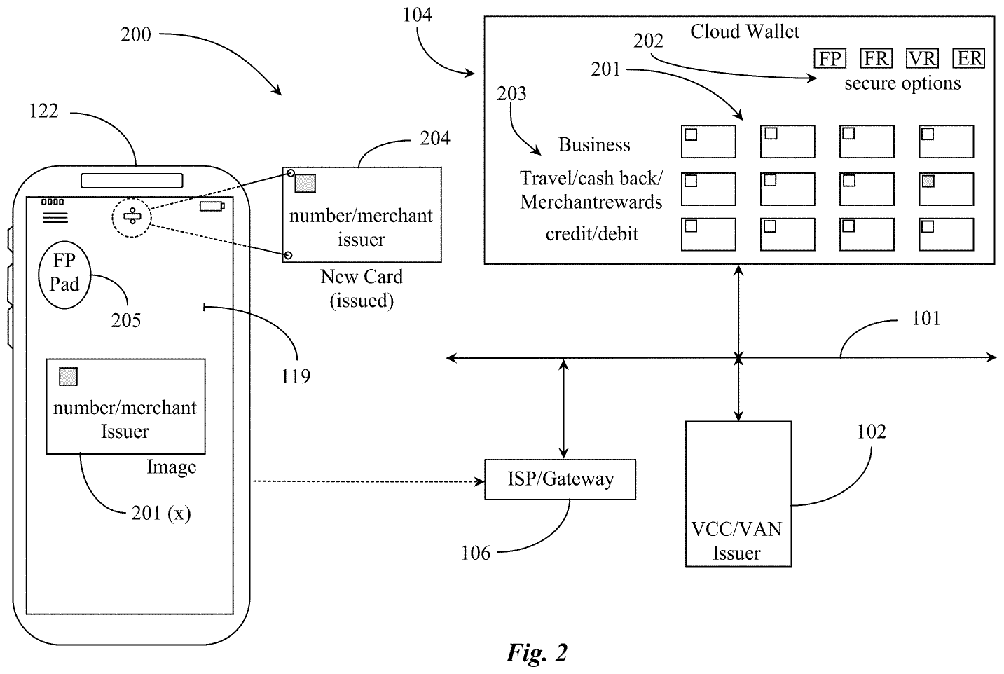

FIG. 2 is an architectural view 200 of a network supported transactional relationship between network nodes and at least one end node initiating a secure transaction using a virtual credit card (VCC) or virtual account number (VAN) according to an embodiment of the present invention. The user's mobile phone 122 has Internet connection through ISP/Gateway 106 to cloud service 104, more particularly to cloud wallet account data categorized by individual accounts 201 into categories 203.

Account categories simply refer to the account organization the user has implemented in his cloud wallet account. Categories 203 include business accounts, travel/cash back/merchant rewards accounts, and credit/debit accounts. There may be more or fewer accounts and account categorizations that are illustrated herein without departing from the spirit and scope of the invention. For example, online banks, and network-hosted accounts may also be represented (virtual banking institutions).

The user operating phone 122 may upload newly issued card account data to wallet service 104 to add a new account. In this view, the user may scan or dock (if equipped) card data 204 into application screen 119 appearing as card 201(x) that is uploaded by the user to wallet service 104 along with at least one biometric signature, in this case a touch screen FP scan window 205. In another embodiment, a user may use a credit/debit card reader connected to their smartphone, the reader initiated by the cloud wallet service 104 through application scree 119 to read and upload credit or debit card data to the account The new card is added as one of accounts 201 and can now be associated with a VCC/VAN number.

To get a VCC/VAN number to use instead of the issued card number, the user makes a request, selects the account, and requests the number. The user may use the VCC/VAN number without a dynamic card like card 118 of FIG. 1 above. For example, if mobile phone 122 is adapted for NFC and the transaction is read by an NFC interface at a POS terminal like terminal 117 of FIG. 1, no additional transaction device is required. In this example, the issuer is financial institution 102 of FIG. 1. However, in other embodiments, the VCC/VAN may be issued by a financial institution that issued the account it is assigned to, or by a third-party entity working with the issuer and the wallet service, or by the wallet service.

Wallet service 104 may allow one or a combination of the listed biometric tests 201 to be used in the request for the VCC/VAN to be used to authenticate the user making sure it is in fact the user and not someone else using the mobile phone. In this embodiment, the issuer 102 generates the VCC/VAN after the wallet service 104 authenticates the user request and passes that to the issuer of the account 201(x) the user selected for the virtual card data or token. The issuer may pass the number directly to the user phone 122 where it appears ready to load onto card 118 in this embodiment. The basic process may be initiated before a transaction is made or during a transaction in process but before approval.

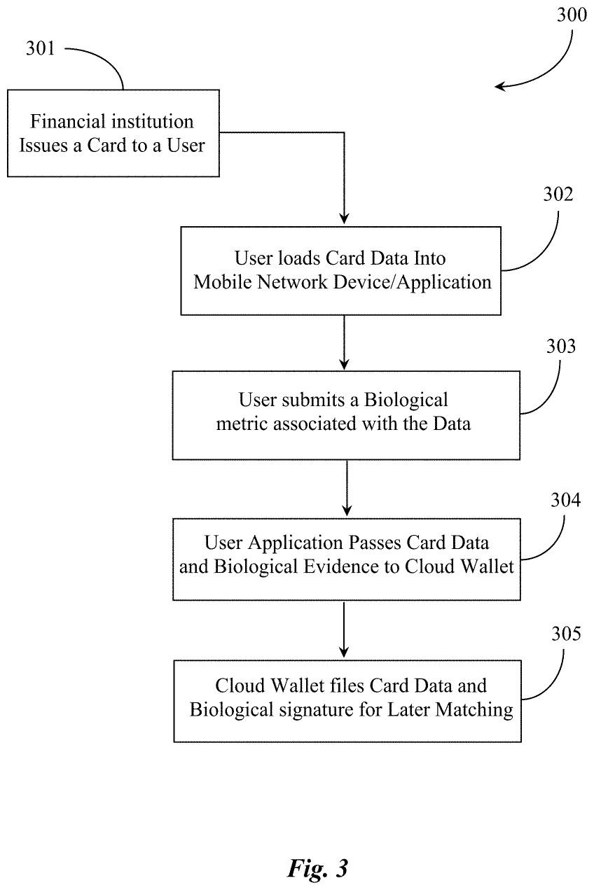

FIG. 3 is a process flow chart 300 depicting steps for improving security for a wallet account. At step 301, a financial institution may issue a card to a user whereas the user receives the card in the mail or inside the institution. The user may load the card data onto the mobile phone into the open application using an optical scanning process or a type interface at step 302. Once loaded the card (image) may be displayed in the application screen. The user may also enter manual card data through web or mobile interface, etc.

At step 303, the user submits at least one biometric sample that is associated with the new card data to the wallet account service. At step 304, the user sends the data and biometric signature to the cloud wallet service. The cloud wallet service may categorize and file the new account in association with the biometric signature(s). In this step, the wallet account may contact the issuer and pass the user data and verification data to the issuer to verify the new account and enable representation of the account via cloud wallet. The biometric signature is used as an on file biometric signature for subsequent match and authentication of the user should the user request a VCC/VAN for the account uploaded.

After the Issuing Bank or third-party VCC or virtual account number (VAN) Supplier verifies the user, their payment card (debit, credit, etc.) is loaded into the user's cloud wallet account and the user is notified that they have successfully added a new card, for example a Starbucks visa rewards card or any other type of account that may be used in an electronic transaction.

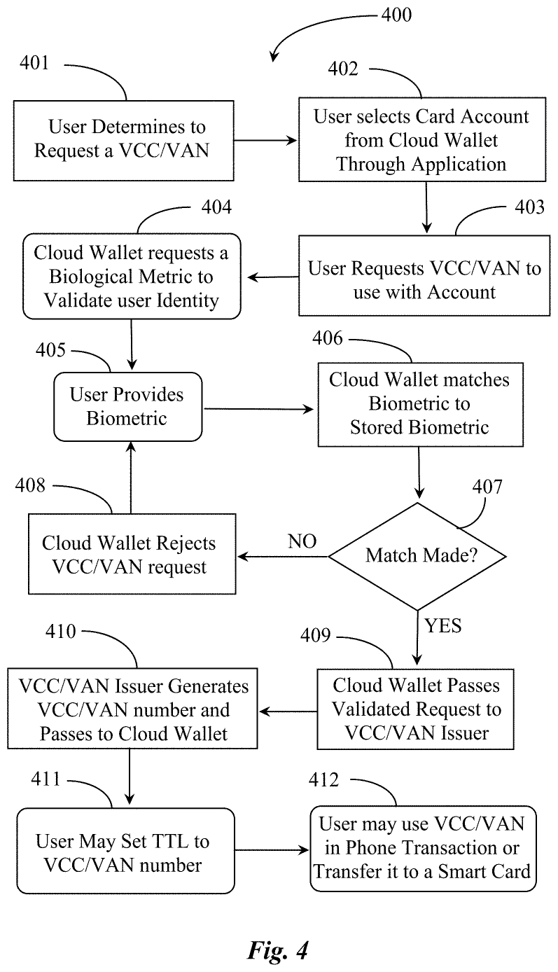

FIG. 4 is a process flow chart 400 depicting steps for requesting a VCC or VAN number and activating that number. At step 401, a user determines to request a VCC or a VAN through the mobile phone application to the wallet account service. At step 402, the user may select an account from their cloud wallet account list through the open mobile application analogous to application 120 and screen 119 on phone 122 of FIG. 1. At step 403, the user may request a VCC/VAN to use for the selected account the VCC/VAN replacing the actual issued card data for security purposes.

At step 404, the cloud wallet server asks the user through the application interface (screen 119, FIG. 1) to submit a fresh biometric of the same type metric previously submitted when uploading the account into the wallet application. The biometric may be one or a combination of a fingerprint scan, facial recognition, voice sample, or ECG. At step 405, the user completes the biometric scan or other biometric measurement. A fingerprint scan may be made on the touch screen for example.

At step 406, the cloud server aided by SW (115, FIG. 1) compares the submitted biometric to the biometric sample currently stored for that account. At step 407, the cloud server (SW 115) determines if a match has been successfully made. If at step 407, the biometric submitted does not match the biometric in storage, the process may move to step 408 wherein the cloud server rejects the user's request for a VCC/VAN for that account. The process may loop back for another attempt. If the cloud server finds a match in the biometrics at step 407, then the cloud server aided by SW 115 forwards the authenticated request to a VCC/VAN issuing entity at step 409, typically the same entity that issued the card in a simple use-case embodiment.

At step 410, the issuing entity may, after receiving authenticated request from the cloud wallet service may generate and send the requested VCC/VAN to the cloud wallet system for the account in question. The VCC/VAN may decide to override the cloud service authentication in some embodiments, perhaps if they have noticed unusual activity on the account, or for other concerns. If the VCC/VAN issuer sends a VCC/VAN, it may also confirm to the service and user that the account number or virtual card or token is ready to use in a transaction.

The cloud wallet service makes the data available to the user through the application at step 410 and may push the VCC/VAN data to the user phone through the mobile application. A step 411, the user may request a time to live (TTL for the VCC/VAN or a number of times for use (x transactions) working through the application screen on the mobile phone. A TTL may be 24 hours, 48 hours, or another time period or the user might request 5 transactions.

In one embodiment the issuing entity may limit TTL and number of transactions depending upon the type of account, state of the account (funds limit) etc. At step 412, the user has a confirmed data set he or she may use on a smart phone for NFC transactions, through a POS website, or at a retail terminal by passing the data to a dynamic smart card or other transaction device using any type of wireless transfer of the information. The information sent to the transaction device may overwrite the previous information, if any loaded onto the transaction device in use.

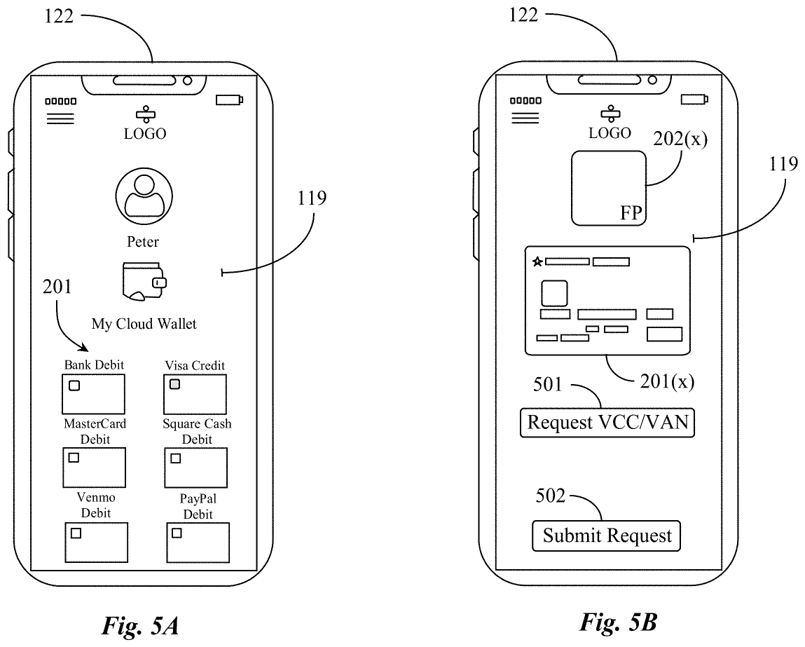

FIG. 5A is an elevation view of the mobile phone of FIG. 1 displaying a cloud wallet application screen according to one embodiment. In this example, mobile phone 122 has application screen 119 displaying a cloud wallet account for Peter. Accounts 201 are all the accounts Peter has uploaded into his cloud wallet through the application referenced as SW 120 of FIG. 1.

FIG. 5B is an elevation of the mobile phone of FIG. 5A depicting a VCC/VAN interactive request interface displayed in screen 119. In this view, Peter has selected one of accounts 201 of FIG. 5A or card 201(x) and is requesting a VCC or VAN to use in association with that account. Peter may interact with a request VCC/VAN option 501 that includes display of a touchscreen fingerprint scan window 202(x), which is one of more than one available biometric feature as described further above. Once Peter has scanned his fingerprint (same digit scanned to authenticate account ownership) then he may submit the request to the cloud wallet server.

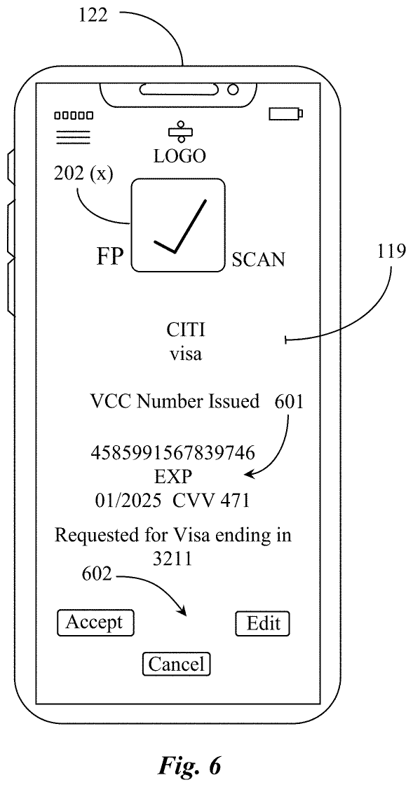

FIG. 6 is a front elevation view of the mobile phone of FIGS. 5A and 5B receiving an approved VCC/VAN/CVV for use or transfer according to an embodiment of the present invention. In this view, the server has received Peter's request including the fresh biometric, in this embodiment, a fingerprint scan. The cloud server aided by SW 115 of FIG. 1, compares the fresh biometric FP scan to the scan image on file for the card account Peter selected. Upon successful validation, FP scan window 202(x) may indicate a visual sign of approval or validation such as a check mark depicted in the window.

In this view, the cloud wallet server has returned an approved VCC/VAN set of card data 601 associated with a Citi Visa card Peter selected. The data may include at least a virtual card number (for dynamic card), VCC/VAN expiration date or transactional allowance, and a dynamically generated card verification value (CVV) number for additional security. The data in this state may be transferred to a writable dynamic smart card for immediate use in a card slot or reader. The data may also be used at a network interface and in another type of transaction device having wireless capability to interact with a POS terminal.

In one embodiment, Peter may be able to accept or decline to use the data after receiving it but before using it. Options 602 include an accept option, a cancel option, and an option for editing. A cancellation of the number has no consequence as the number is unique. Acceptance of the data confirms state and that the VCC/VAN will be used per characterization like TTL, number of transactions, per-negotiated limits, etc. In one embodiment, a user may edit parameters as a request and the wallet service may reissue another data set and force another biometric scan. In another embodiment, edits may be made within reason as it may pertain to security concerns.

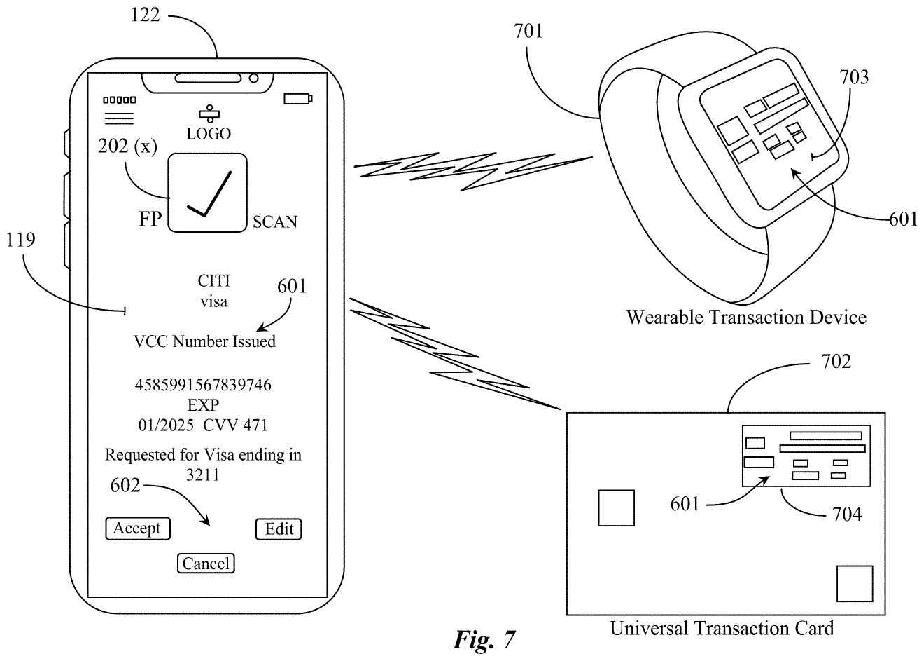

FIG. 7 is an elevation view of the mobile telephone of FIG. 1 transferring VCC/VAN/CVV data to at least two transaction devices. Mobile phone 122 has in this view, the VCC/VAN/CVV data on board and approved for use by the issuing entity. The content and order of screen 119 is analogous to that depicted in FIG. 6. Upon notification of approval for use of the card data sent, Peter may transfer the data wirelessly to dynamic smart card 702, or to wearable wireless transaction device 701 in the form of a watch having NFC capability and Bluetooth™ capability.

Dynamic smart card 702 may include display screen 704 that may include a display of data 601 partially redacted in display. Wearable transaction device 701 includes display screen 703 displaying card data 601. In one embodiment, VCC/VAN data may be approved for use only to a specific device whereas in repetitive use, the card data may be declined if the host device changes. In one embodiment, the card data is approved for use on more than one transactional device or platform that a user has registered with the wallet service or with the issuing entity. In one embodiment, a wallet service may revoke or deactivate an active VCC/VAN number by alerting the issuer to a breach or other unusual use patterns.

If a user desires to extend a TTL for a VCC or VAN for more than one transaction, for example, the user may select or enter a time period like 24 hours, 1 week, or the like through the mobile application while connected to the cloud server. The cloud wallet server may pass the information to the issuing entity so that it is known how long the card may be used.

A user may use a VCC or VAN with an account to purchase online tickets. In this embodiment, a tag like a QR code or a bar code may be generated and downloaded to the user'[s mobile phone, which may be displayed on the screen through the mobile application at entry points of the venue the tickets were purchased for. A VCC or VAN code may be presented to a merchant or agent for plane tickets, subway tickets, ride platforms, car rentals hotel rooms and theater seats.

In an alternate embodiment, a VCC or VAN could be generated and assigned to a regular debit card (not dynamic) as a proxy. In this case the user may have to pay double interchange fees if the VCC or VAN generated was linked to a credit card account, but it would still work and provide additional fraud protection.

In one embodiment, the user does not maintain a cloud wallet service and VCC or VAN numbers are sent directly to their payment devices like a smart card, dynamic smart card, mobile wallet (on their smart phone), or to their wearable NFC payment device. In still another embodiment, the cloud wallet service may generate the VCC or VAN for a user upon their request obfuscating an issuing bank or third-party service specialist. In another embodiment the user can request a virtual Debit card (VDC) instead of a VCC or VAN. A VDC may be associated to one or more of the users existing debit cards.

### Biometrically Triggered Security Switch for Near Field Communications (NFC)

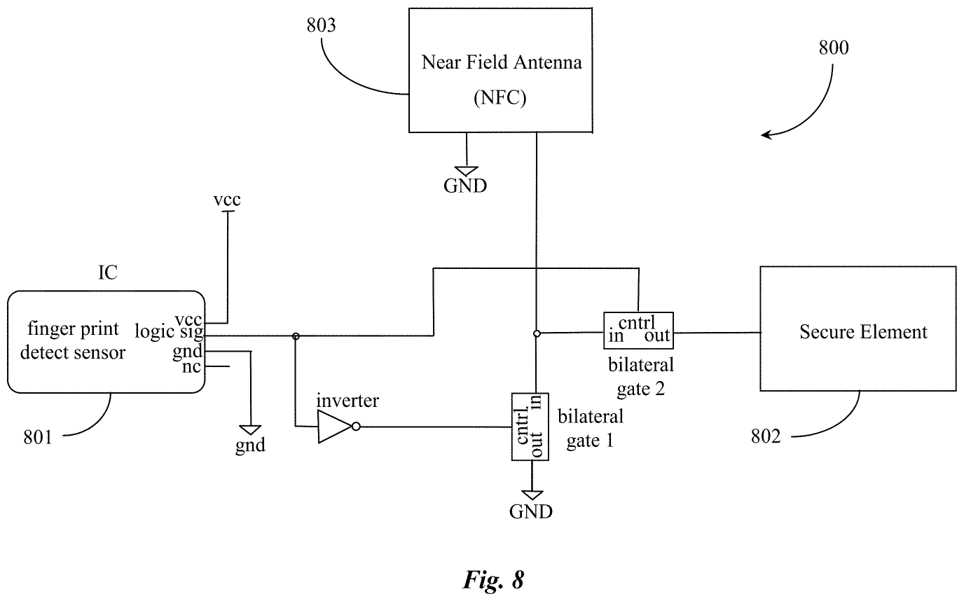

FIG. 8 is a block diagram depicting a near field communication (NFC) shut-down circuit 800 according to an embodiment of the present invention. Circuit 800 is an NFC disrupt circuit that may be toggled using a biometric authentication process to improve security against undesired data transfers that may occur if an NFC chip not involved in a transaction is in field communication range of an NFC reader.

Circuit 600 may be added to any NFC capable device on chip and may be integrated with a biometric scheme such as a fingerprint authentication process to turn on NFC for a transaction wherein the normal state for the NFC chip is power off. In this embodiment, NFC is kept in a default state of powered off and cannot be powered on without successful matching of biometric data held on the device with a fresh biometric sample submitted by the user before conducting a transaction. Circuit 800 integrates the NFC antennae 803, a secure element 802 temporarily storing the card account data or VCC/VAN data described further above. In a preferred embodiment, circuit 800 relies on leveraged biometric features available like a fingerprint scanner/sensor having connection to bilateral gates that control toggling of the NFC features namely antennae 803 and secure element (memory) 802.

In an off state, which is the default state, bilateral gate 1 is presented with logic 1 voltage on the controller (CNTRL) input causing any signal from the NFC antenna to be grounded. To prevent the secure element from leaking any data or being read or accessed, a bilateral gate 2 is presented with logic 0 voltage on its controller input. This state produces a high impedance condition preventing any residual signal from being passed or received from any interior circuitry of an NFC chip such as secure element 802.

In an off state, the NFC feature cannot be used. An on state for NFC enablement and use may only be enacted if the user has successfully entered a biometric signature that matches a previous signature stored on the user's mobile device. Another embodiment allows for a secret code or password to be entered through a device keypad to turn on the NFC chip for use. If a user passes a FP scan, the FP detection sensor 801 (a separate but integrated chip) puts out a logic 1 voltage to bilateral gate 2 resulting in a low impedance power state condition enabling NFC data to pass to and from the secure element 802.

The FP detection sensor 801 may put out a logic 0 voltage to bilateral gate 1 resulting in a high impedance state for NFC antennae 803 that prevents the NFC signal from grounding out thereby maintaining NFC signal integrity for use. In a preferred embodiment, fingerprint sensor 801 is integrated with the NFC device so that the normal mode for the NFC device is powered is off. If the user summits a correct fingerprint scan, power is supplied to the NFC components i.e. antennae 803 and secure element 802. In a preferred embodiment, the power state enabling the NFC device is automatically set back to default or power off after each transaction made with the device. The user must successfully submit a subsequent fingerprint scan (FPS) to make a subsequent transaction using NFC.

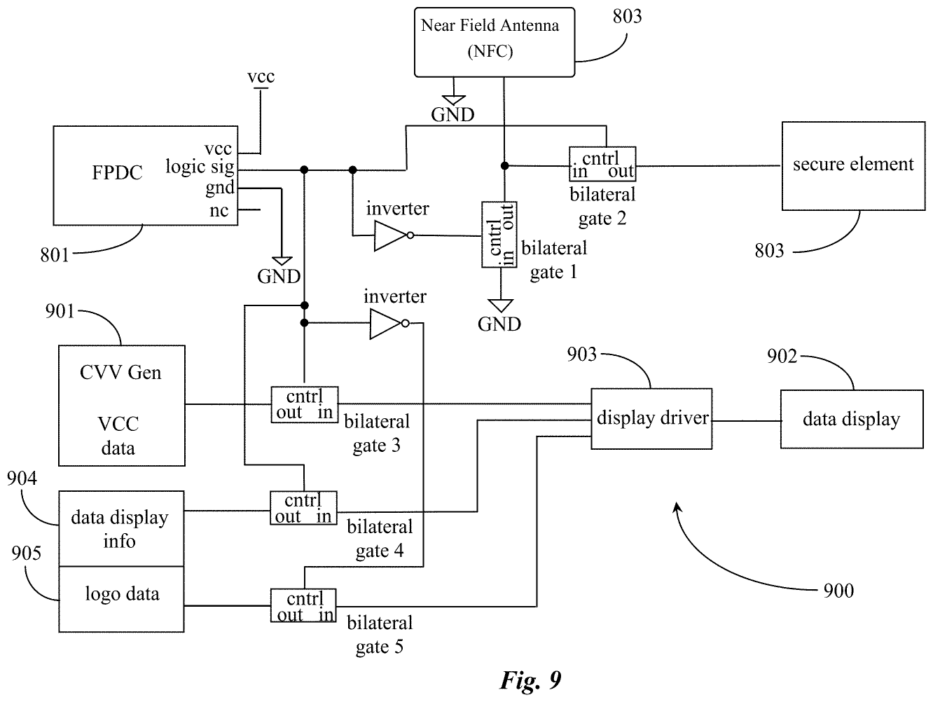

FIG. 9 is a block diagram depicting the NFC shut-down circuit of FIG. 8 with added circuitry 900 for preventing display of at least the static or dynamic card verification value (CVV) on the transaction device. Circuitry 900 includes three added logic gates integrated in series with the fingerprint detection sensor 801. The circuitry further integrates the FPS 801 to a secure element (memory) 901 adapted to store a CVV and any VCC/VAN data, a secure element 904 containing data for display, and element 905 containing logo information for display.

Logic gates 3, 4, and 5, are integrated between the elements holding data and the display driver and display screen of the transaction device. The fingerprint sensor 801 is used to manipulate logic gate 3 for preventing CVV on a static or dynamic card for example, from being displayed on data display 902 prior to fingerprint approval to turn on NFC. Bilateral gate 4 is manipulated to prevent a card number or VCC/VAN number such as the 16-digit card number from being displayed on display device 902. When the transaction device, in this case a dynamic card is in lock down mode, bilateral gate 5 is manipulated to send an alternate image like a logo or screen save image to display device 902. In this way, a user does not inadvertently display any secure data or information before making a transaction.

### Dynamic CVV

In one embodiment representing an extension of the fingerprint manipulation of gates to control power and data presentation, the inventor provides a method that allows dynamic CVV numbers to be authenticated based on a fingerprint sensor like sensor 801 using the existing circuitry. Dynamic CVV numbers may be generated every few seconds based on an algorithm in order to be part of an EMV tokenization process. In a full feature dynamic card, a dynamic CVV may be controlled based on biometric authentication in a generally more expensive product. However, existing plastic cards use simple components to generate dynamic CVVs and a separate component to authenticate based on a fingerprint sensor. The inventor has provided an electrical-circuit-based method of controlling the dynamic CVV generation process from the fingerprint sensor 801 without using an additional microcontroller or other components thus keeping manufacturing costs down and comparable with existing dynamic smart cards.

The invention is this simple electrical circuit that will turn off dynamic CVV generation until FP authentication has been secured.

This embodiment leverages the fact that a dynamic card can store multiple numbers (CC numbers) and allows the user to choose which number is active at any given time. Because of this capability, the card can be manipulated into a high security mode in which it activates a special security number on the card in between actual transactions to identify any transaction arising from a theft rather than from a valid card number. In one embodiment, the token for the suspicious transaction may collect and store information about the user that is making or made the transaction and may alert the merchant that a fraudulent transaction is or has occurred.

It will be apparent with skill in the art that the VCC/VAN distributing system of the present invention may be provided using some or all the elements described herein. The arrangement of elements and functionality thereof relative to the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. A method for authenticating dynamically generated virtual credit card (VCC) data or virtual account number (VAN) data assigned to an electronic account for network distribution to one or more than one transaction device for use in electronic transacting including the steps:
(a) issuing from a first service entity having a first server connected to the network, one or more money accounts to a user owning the one or more than one transaction device, the one or more money accounts stored at the first service entity or at a second service entity having a second server connected to the network as account transaction data on at least one data repository connected to the network, the one or more money accounts authenticated to the user by at least one biometric sample submitted to the first or second service entity for repeated reference to authenticate the user;
(b) requesting a dynamic virtual credit card number or a virtual account number from the second or first service entity, or from a third service entity having a server connected to the network, the request generated through a mobile service application running on the one or more than one transaction device to represent the transactional data of one of the one or more money accounts;
(c) submitting at least one or a combination of biometric samples to the second or first entity servers to obtain user verification for the request of (b);
(d) comparing the submitted biometric signature(s) to the biometric signature of (a);
(e) upon successful verification result in (d), sending the verification and request data to the issuing first service entity over the network from the second service entity, or to the third service entity of (b).
(f) upon receiving verification success and request data of (e), generating at the first, second or third service entities a VCC or a VAN and sending that and confirmation of active status of the VCC/VAN to the one or more than one transaction device or to one of the other service entities for subsequent distribution to the one or more than one transaction device.

2. The method of claim 1, wherein in (a) the first service entity is a financial institution that issued the money account or accounts and wherein the second service entity is a wallet account service.

3. The method of claim 1, wherein in (a) the biometric sample is one or a combination of a fingerprint scan, a voice sample, a facial recognition image, or an electrocardiogram sample.

4. The method of claim 1, wherein in (a) the one or more transaction device is a mobile phone, or a dynamic smart card wirelessly paired to a mobile phone.

5. The method of claim 1, wherein in (b) the mobile service application is running of a transaction device that is a mobile phone.

6. The method of claim 2, wherein in (c) the one or more than one biometric samples include a fingerprint scan submitted to the wallet account service, which in turn contracts with the financial institution for generating and activating the VCC/VAN requested or for activation of the VCC/VAN requested, the VCC/VAN generated by the wallet service or the third service entity.

7. The method of claim 6, wherein in (c) the third service entity generates the dynamic VCC/VAN numbers as a specialized service on demand.

8. The method of claim 1, wherein in (d) the comparison is made at the wallet account service functioning as the second service entity.

9. The method of claim 1, wherein in (e) the second service entity is the wallet account service and the first service entity is the financial institution that issued the one or more money accounts.

10. The method of claim 1, wherein in (f) the VCC or VAN includes a card number, an expiration time or date, and a credit verification value (CVV).

11. The method of claim 1, wherein in (f) the VCC or VAN has a time to live measured in hours.

12. The method of claim 1, wherein in (f) the VCC or VAN may be used for a stated number of transactions.

13. The method of claim 1, wherein in (f) the VCC or VAN may be used for a single transaction.

14. The method of claim 1, wherein in (f) the VCC or VAN is used by a dynamic smart card at a point of sale terminal (POS) having a card reader.

15. The method of claim 1, wherein in (f) the VCC or VAN is used by a mobile phone having a near field communications (NFC) chip at a POS having an NFC interface.

16. The method of claim 1, wherein in (f) the VCC or VAN is distributed to a wearable transaction device in the form of a watch.
